(19) United States
(12) Patent Application Publication
(10) Pub. No.: US 2026/0242284 A1
(43) Pub. Date: Aug. 20, 2026

(54) FREE RADICAL-CURABLE ACRYLIC POLYOL RESIN COMPOSITION FOR MANUFACTURING QUARTZ-BASED ARTIFICIAL STONE WITH IMPROVED UV RADIATION AND WEATHER RESISTANCE

(71) Applicant: A & A GREEN PHOENIX GROUP JOINT STOCK COMPANY, Ha Noi City (VN)

(72) Inventors: Nang Xuan Ho, Hanoi City (VN); Dieu Vinh Tran, Hanoi City (VN); Ha Thi Ha, Hanoi City (VN); Huong Thu Ha, Hanoi City (VN)

(21) Appl. No.: 18/995,260

(22) PCT Filed: Sep. 12, 2023
(86) PCT No.: PCT/IB2023/020057

§ 371 Date: Jan. 16, 2025

(30) Foreign Application Priority Data
Dec. 15, 2022 (VN) 1-2022-08215

(51) Int. Cl. C04B 26/06; C04B 14/06; C04B 111/20; C08F 220/18

(52) U.S. Cl. CPC C04B 26/06; C04B 14/06; C08F 220/1804; C04B 2111/2076; C04B 2201/50; C08F 2800/20

(57) ABSTRACT

The invention relates to the thermosetting acrylic polyol resin synthesized from block copolymerization of monomer n-BMA with a weight ratio in the range of 51.5% to 60.5%, styrene monomer with a weight ratio in the range of 5% to 15.5%, HEMA or HEA with the weight ratio in the range of 33.5% to 46.5% and cured by free radical reaction with a catalyst-accelerator which is an oxidation-reduction system, for manufacturing artificial stone to enhance UV and weather resistance with organic peroxide compounds as a catalyst in the range of 0.1 to 5% by weight of the acrylic resin and cobalt salt compounds or metal salt compounds as a accelerator in the range of 0.005% to 1% by weight of the acrylic resin. The acrylic resin of the present invention has excellent UV and weather resistance with color variation index ΔE*≤2 after 1000 hours of UV exposure. The artificial stone product using the acrylic polyol resin composition of the present invention as a binder in the range of 5% to 20% by weight of mixture and inorganic granular reinforcements in the range of 80% to 95% by weight of the mixture, has physico-mechanical properties that meet technical requirements and excellent UV resistance with color variation index ΔE≤2 after 1000 hours of UV exposure.

### FIELD OF THE INVENTION

The present invention relates to a thermosetting acrylic polyol resin composition having ultraviolet (UV) radiation and weather resistance which is synthesized by block copolymerization of monomer n-butyl methacrylate (n-BMA), styrene, hydroxyethyl methacrylate (HEMA) or 2-hydroxyethyl acrylate (HEA) using the initiator of dibenzoyl peroxide or di-t-butyl peroxide or azo-di-isobutylronitrile. The present invention further relates to artificial stone products, using a matrix phase of acrylic polyol resin of the present invention and reinforced by quartz granular having flexural strength in the range of 40 to 120 N/mm², deep abrasion in the range of 89 to 175 mm³, water absorption in the range of 0.01% to 0.05%, impact resistance ≥3 J, and particularly excellent UV radiation resistance with color variation index ΔE≤2 after 1000 hours of UV exposure on the Accelerated UV Testing.

### BACKGROUND OF THE INVENTION

Acrylic polyol resin is a popular thermosetting plastic in the world, which has been researched, produced and applied for decades. Acrylic polymers were first studied in 1880 by the Swiss chemist Georg WA Kahlbaum. In 1901, in Germany, Otto Rohm described his work on acrylate synthesis in “The polymerization of acrylic acid”, his doctoral thesis was later patented for this acrylic resin synthesis in 1915. Poly(methyl)methacrylate was first marketed in Germany by Rohm and Haas in 1927.

To synthesize thermosetting acrylic polyol resins, different monomers can be used to meet the requirements. The monomers participating in the reaction to form thermosetting acrylic copolymers have different roles such as monomers methyl methacrylate, styrene, n-butyl methacrylate, 2-ethylhexyl acrylate, hydroxyethyl methacrylate, 2-hydroxyethyl acrylate, butyl acrylate, acrylamide, to form acrylic polyol resin with weather resistance, and methyl methacrylate monomers with long substituents to form water-resistant acrylic resins . . . .

In the thermosetting acrylic resin system, the obtained copolymer has hydroxyl functional groups which participate in direct reaction with curing agents such as isocyanate adducts, amino resin, epoxy resin to form a polymer with spatial structure. In that case, it is necessary to use monomers such as hydroxyethyl methacrylate, 2-hydroxyethyl acrylate, butyl acrylate, etc.

CN103613698A disclosed acrylic resin having both epoxy functional group and hydroxyl functional group, epoxy equivalent (weight) is 570~630 g/mol, hydroxyl index is 40~50 mgKOH/g, the acrylic resin contains carboxyl groups using curing agents of amino, isocyanic esters at the normal temperature or heated with curing agent with the ratio in the range of 1 to 10% by the weight of the resin, and electrostatic coating application thereof. After curing, the paint has very good weather resistance, good flowability, good surface hardness and high gloss, which can be applied to different shaped materials, or indoor or outdoor building materials.

U.S. Pat. No. 4,985,517A disclosed an acrylic resin formed by copolymerization of a monomer mixture consisting of acrylate alkyl (meth) substituted with a hydroxy, alkyl methacrylate or vinyl aromatic and higher alpha-olefin. The document relates to low molecular weight acrylic resin that cures with polyepoxide, di-isocyanate, urea-aldehyde, benzoguanamine-aldehyde or melamine-aldehyde at the normal temperature or at 150° C. for 1 hour, and application there for electrostatic coating with UV radiation and weather resistance.

However, the disadvantages of acrylic resin cured by functional groups such as epoxy resin or melamine formaldehyde resin are low hardness, long reaction time, and high curing temperature (150÷180° C.), thus not suitable for applications in production technology of quartz-based artificial stone. On the other hand, the existence of aromatic cyclic functional groups from these functional group curing agents in cured acrylic resins is responsible for the poor UV and weather resistance of acrylic resins. In order to increase the hardness, reduce curing time, curing temperature, increase the UV radiation and weather resistance, the present invention relates to the method of curing acrylic polyol resin according to the free radical reaction by the catalyst-accelerator which is an oxidation-reduction system in accordance with the requirements in the quartz-based artificial paving stone industry.

### SUMMARY OF THE INVENTION

The object of the present invention is to provide a thermosetting acrylic polyol resin cured by free radical reaction with UV radiation and weather resistance which is suitable for manufacturing quartz based artificial stone. The thermosetting acrylic polyol resin of the present invention is synthesized from n-butyl methacrylate (n-BMA) monomer, styrene monomer (SM), hydroxyethyl methacrylate monomer (HEMA) or 2-hydroxyethyl acrylate monomer (HEA) using the initiator of dibenzoyl peroxide or di-t-butyl peroxide or azo-di-isobutylronitrile and cured by free radical reaction with a catalyst-accelerator which is an oxidation-reduction system, suitable for the requirements in the quartz-based artificial stone industries.

Therefore, the present invention provides an acrylic polyol resin having excellent UV radiation and weather resistance cured by free radical mechanism applied in the artificial stone manufacture, characterized in that:
i) the acrylic polyol resin having ultraviolet radiation and weather resistance that is synthesized from block copolymerization of n-BMA, SM, HEMA or HEA, wherein:
n-BMA in the range of 51.5% to 60.5% by weight;
SM in the range of 5.0% to 15.5% by weight;
HEMA or HEA in the range of 33.5% to 45.6% by weight;
initiator of curing reaction was chosen from the group consisting of dibenzoyl peroxide or di-t-butyl peroxide or azo-di-isobutylronitrile in the range of 0.01% to 2% by weight calculated by the total weight of the mixture of monomers; and
ii) the acrylic polyol can be cured by free radical reaction which is an oxidation-reduction system with a catalyst of organic peroxides and accelerator of cobalt salts or manganese salts or salts of transition metals wherein:
organic peroxides are chosen from the group consisting of: tert-butylperoctoate; tert-butylperoxy benzoate; tert-butyl peroxy-3,5,5-trimethylhexanoate; ter-butyl peroxy pivalate; tert butyl peroxy-2 ethyl hexanoate; tert butyl peroxy-isobutyrate; tert butyl-mono peroxy-maleate; tert butyl peroxy-neoheptanoate; tert butylperoxy-neodecanoate; di(4-methyl benzoyl)peroxide; diluaroyl-peroxide; 2,5-dimethyl-2-5-di(2-ethylhexanoylperoxy)hexane; di(3,5,5-trimethyl-hexanoyl)peroxide; tert amylperoxy-neodecanoate; 1,1,3,3-tetramethyl butyl peroxy-neodecanoate in the range of 0.1 den 5% by weight calculated by the weight of acrylic polyol resin, and
accelerator is chosen from a group consisting of cobalt (II) salt compounds such as cobalt octoate, manganese salts, or metal salt compounds the like in the range of 0.005% to 1% by weight calculated by the weight of acrylic polyol resin;
(iii) the acrylic polyol resin of the present invention has characteristics: solid content in range from 40% to 80%; color according to Hazen scale ≤10; liquid density in the range of 1.01 to 1.2 g/cm³ at the temperature of 23° C. and the relative humidity of 57%; viscosity in the range of 600 to 3000 mPa·s at the temperature of 23° C.; tensile strength in range from 40 to 60 MPa; flexural strength in range from 60 to 120 MPa; barcol hardness in range from 40 to 55; UV radiation and weather resistance with color variation index ΔE≤2 after 1000 hours of UV exposure on the Accelerated UV Testing according to standard of ASTM G154-06:2006.

The present invention also provides quartz-based artificial stone products using the matrix phase of the acrylic polyol resin of this invention in the range of 5% to 20% by weight and reinforcements that are inorganic compounds in the range of 80% to 95% by weight, wherein:
quartz, cristobalite, sand, and sand or glass derivatives materials with particle size lower than 0.045 mm in the range of about 10% to 37.5% by weight calculated on the total weight of the mixture;
quartz, cristobalite, sand, and sand or glass derivatives materials with particle size from 0.045 mm to 0.1 mm in the range of 15 to 42.5% by weight calculated on the total weight of mixture;
quartz, cristobalite, sand, and sand or glass derivatives materials with a particle size from 0.1÷0.5 mm in the range of 10% to 37.5% by weight calculated on the total weight of mixture;
quartz, cristobalite, sand, and sand or glass derivatives materials with a particle size from 0.5÷2.5 mm in the range of 17.5% to 45.6% by weight calculated on the total weight of mixture;
quartz, cristobalite, sand, and sand or glass derivatives materials with a particle size from 2.5÷6.0 mm in the range of 20% to 47.5% by weight calculated on the total weight of mixture;

The artificial stone product using the matrix phase of the acrylic polyol resin of this invention has physico-mechanical properties: i) flexural strength in the range of 40 to 120 N/mm²; ii) deep abrasion in the range of 89 to 175 mm³; iii) water absorption in the range from 0.01% to 0.05%; iv) impact resistance ≥3 J; v) particularly, excellent UV resistance with color variation index ΔE≤2 after 1000 hours of UV exposure on the Accelerated UV Testing.

### BRIEF DESCRIPTION OF DRAWINGS

FIG. 1: Thermal-curing acrylic resin before (1) and after (2) curation by free radical reaction.

FIG. 2: FTIR spectrum showing the chain-stitching ability of acrylic polyol resins (sample 1, sample 2 and sample 4 are control samples, sample 3 is the sample of this present invention).

FIG. 3: TGA and DTG curves of the samples of after-cured acrylic polyol resins burned under atmospheric conditions.

FIG. 4: FTIR spectrum of free radical reaction-cured acrylic resin (sample 1) before and after 1000 hours of UV exposure on the Accelerated UV Testing (control sample).

FIG. 5: FTIR spectrum of free radical reaction-cured acrylic resin (sample 2) before and after 1000 hours of UV exposure on the Accelerated UV Testing.

FIG. 6: FTIR spectrum of free radical reaction-cured acrylic resin (sample 3) before and after 1000 hours of UV exposure on the Accelerated UV Testing.

FIG. 7. FTIR spectrum of free radical reaction-cured acrylic resin (sample 4) before and after 1000 hours of UV exposure on the Accelerated UV Testing.

FIG. 8. Images of the surfaces of the artificial stone products using the matrix phase of the acrylic resin—sample 1, sample 4 (control sample) after curing (a, b) and after polishing (c).

FIG. 9: Images of the surfaces of the artificial stones using the matrix phase of the acrylic resin—sample 3 (of the present invention) and PEKN resin (control sample) after curing (a) and polishing (b).

FIG. 10: The color variation of the artificial stone products using the matrix phase of acrylic polyol resin (sample 1, sample 2, sample 3 and sample 4) and unsaturated polyester resin (UPR) after 1000 hours of UV exposure on the Accelerated UV Testing.

FIG. 11: Images of scanning electron microscopy (SEM) at 500× magnification of artificial stone sample using acrylic polyol resin (sample 2) before (a) and after (b) 1000 hours of UV exposure on the Accelerated UV Testing.

FIG. 12: Images of SEM at 500× magnification of artificial stone sample using the matrix resin (sample 4) before (a) and after (b) 1000 hours of UV exposure on the Accelerated UV Testing.

FIG. 13: Images of SEM at 500× magnification of artificial stone sample using matrix UPR resin before (a) and after (b) 1000 hours of UV exposure on the Accelerated UV Testing.

FIG. 14: Images of SEM at 500× magnification of artificial stone sample using resin sample 3 before (a) and after (b) 1000 hours of UV exposure on the Accelerated UV Testing.

### DETAILED DESCRIPTION

Ultraviolet radiation and weather-resistant acrylic polyol resin as described in the present invention is an acrylic polyol resin synthesized by block copolymerization of monomers n-butyl methacrylate (n-BMA), styrene monomer (SM), hydroxyethyl methacrylate (HEMA) or 2-hydroxyethyl acrylate (HEA). Block copolymerization of monomers forms acrylic polyol resin according to the following scheme:

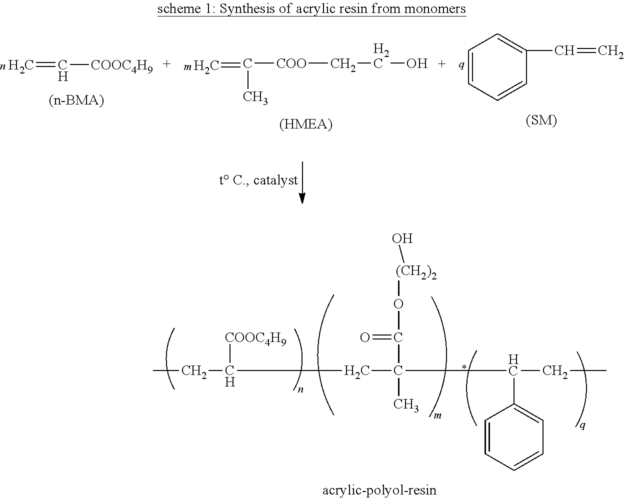

In the present invention, the first monomer acrylate is used as n-butyl methacrylate (n-BMA) in the range of 51.5% to 60.5% by weight in order to increase gloss, hardness, flexibility in resin and increase UV and weather resistance of obtained acrylic resin.

The second monomer acrylate is used as hydroxyethyl methacrylate (HEMA) or 2-hydroxyethyl acrylate (HEA) in the range of 33.5% to 45.6% by weight in order to increase elasticity, provide polarizing group OH— that helps post-synthesized acrylic resin to react with isocyanate adducts creating cross-linking. This help improve UV and weather resistance of the obtained acrylic resin in outdoor application.

According to the present invention, styrene monomer is used in the range of 5.0% to 15.5% by weight aimed at impact resistance, wear resistance and increased hydrophobicity for resin. Styrene also makes the chain-stitching form cross-linkings in the chain of acrylic polyol resin occur faster and more thoroughly in the presence of organic peroxide catalysts and accelerator as cobalt salts or manganese salts.

According to the present invention, finished acrylic polyol resin cures by free radical reaction with a catalyst-accelerator which is an oxidation-reduction system, the free radical is formed by following reaction mechanism:

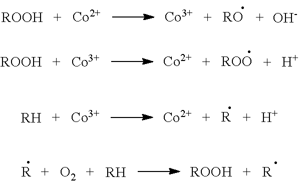

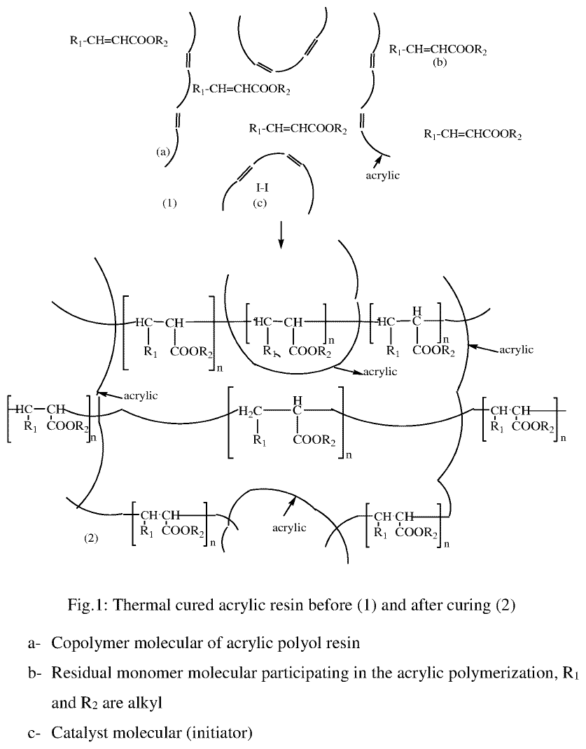

The curing reaction of thermal-cured acrylic polyol copolymers forms polymer which has three-dimensional structure as shown in FIG. 1.

According to the present invention, the catalyst used in the curation of the finished acrylic polyol resin is organic peroxide compounds as: tert-butylperoctoate; tert-butyl peroxybenzoate; tert-butyl peroxy-3,5,5-trimethylhexanoate; ter-butylperoxy-pivalate; tert butyl peroxy-2 ethylhexanoate; tert butyl peroxy-isobutyrate; tert butyl-monoperoxy-maleate; tert butyl peroxy-neoheptanoate; tert butylperoxy-neodecanoate; di(4-methyl benzoyl)peroxide; diluaroyl-peroxide; 2,5-dimethyl-2-5-di(2-ethylhexanoylperoxy)hexane; di(3,5,5-trimethyl-hexanoyl)peroxide; tert amylperoxy-neodecanoate; 1,1,3,3-tetramethyl butylperoxy-neodecanoate in the range of 0.1 to 5% calculated by the weight of acrylic polyol resin;

According to the present invention, the accelerator used in the curation of the acrylic polyol resin is cobalt (II) salt compounds such as cobalt octoate or manganese salts or metal salt compounds the like in range from 0.005% to 1% by the weight of acrylic polyol resin.

In the present invention, the curing temperature of the free radical cured acrylic polyol resin is in the range from 80° C. to 180° C.

In the present invention, the curing time of the free radical cured acrylic polyol resin is in range from 30 to 120 minutes.

The finished acrylic polyol resin of the present invention meets the requirements of the quartz-based artificial stone manufactured industry and has technical characteristics as shown in Table 1:

TABLE 1
The technical characteristic requirements of acrylic polyol resin

| Technical parameters | Testing method | Value |
|---|---|---|
| Color, Hazen | ASTM D8005-18 | ≤10 |
| Solid content (120° C.-2 giò'), % | ASTM D1259-06 | 40-80 |
| Liquid density 23° C., g/ml | ASTM D1475-13 | 1.01 ÷ 1.20 |
| Brookfield viscosity at 23° C., mPa · s | ASTM C1824-16 | 600 ÷ 3000 |
| Geling time, minute | EN584-00 | 10 ÷ 25 |
| Maximum curing time, minute | EN584-00 | 15 ÷ 35 |
| Maximum curing temperature, ° C. | EN584-00 | 200 ÷ 230 |
| Barcol hardness | ASTMD2583 | 40 ÷ 55 |
| Tensile strength, MPa | ISO 527: 1996 | 40 ÷ 60 |
| Flexural strength, MPa | ISO 178: 1993 | 60 ÷ 120 |
| Tensile module, GPa | ISO 527: 1996 | 2.5 ÷ 5.0 |
| Flexural module, GPa | ISO 178: 1993 | 2.5 ÷ 5.0 |
| The color variation after irradiating | Standard of irradiating UV: | ≤2 |
| UV for 1000 hours has ΔE index | ASTM G154-06: 2006 | |
| | Standard of determining | |
| | ΔE index: ASTM E313-10: | |
| | 2010 | |

According to the present invention, the artificial stone product uses acrylic polyol resin binder in the range of 5% to 20% by weight and inorganic granular reinforcement in the range of 80% to 95% by weight.

The properties of artificial stone depend on the aggregate particle size distribution and their proportion in the composition thereof. The basic formula of granular aggregates includes the large particle sizes (from 0.1 mm or larger) and the fine particles (smaller than 0,045 mm). Preferred embodiments of granular aggregate mixtures are the ones that contain both the particles having large particle sizes and the particles having small particle sizes in an optimal ratio. An optimal formula is that the granular aggregate used must be optimized to ensure the most compact arrangement of aggregate particles and create a dense structure of the resulting material. Thus, in the present invention, granular aggregates, which have different particle size, is used as follows:
quartz, cristobalite, sand, and sand or glass derivatives materials with particle size lower than 0.045 mm in the range of 10% to 37.5% by weight of the mixture;
quartz, cristobalite, sand, and sand or glass derivatives materials with particle size from 0.045 mm to 0.1 mm in the range of 15 to 42.5% by weight of mixture;
quartz, cristobalite, sand, and sand or glass derivatives materials with a particle size from 0.1÷0.5 mm in the range of 10% to 37.5% by weight of mixture;
quartz, cristobalite, sand, and sand or glass derivatives materials with a particle size from 0.5÷2.5 mm in the range of 17.5% to 45.6% by weight calculated on the total weight of mixture;
quartz, cristobalite, sand, and sand or glass derivatives materials with a particle size from 2.5÷6.0 mm in the range of 20% to 47.5% by weight of mixture;

In the present invention, the curing temperature of the artificial stone product using the matrix phase of acrylic polyol resin and inorganic granular aggregates as reinforcements is in the range of 80° C. to 180° C.

In the present invention, the curing time of artificial stone products using the matrix phase of acrylic polyol resin and inorganic granular aggregates as reinforcements is in range from 30 to 120 minutes.

According to the present invention, the quartz-based artificial stone product using the matrix phase of acrylic polyol resin and inorganic granular aggregates as reinforcements has several properties as shown in Table 2:

TABLE 2
Physical and mechanical properties of the artificial
stone product using acrylic polyol resin

| Physical and mechanical | | |
|---|---|---|
| properties | Testing method | Value |
| Water absorption, % | BS EN 14617-1: 2013 | 0.01 ÷ 0.05 |
| Flexural strength, N/mm² | BS EN 14617-2: 2016 | 40.0 ÷ 120.0 |
| Impact resistance, J | BS EN 14617-9: 2005 | ≥3.0 |
| Scratch hardness of the surface, | EN 101: 1991 | 6.0 ÷ 8.0 |
| Mohs | | |
| The color variation after | Standard of irradiating UV: | ≤2 |
| irradiating UV for 1000 hours | ASTM G154-06: 2006; | |
| has ΔE index | Standard of determining ΔE | |
| | index: ASTM E313-10: 2010 | |

### EXAMPLES

The invention is illustrated by the following examples, but these examples should not be construed to limit the scope of the invention in any way.

### Example 1: Synthesis of 1000 g of the Acrylic Polyol Resin

The control samples and the samples of the present invention are prepared as shown below.

| | Weight, g | | | |
|---|---|---|---|---|
| | | | Sample 3 | |
| | Sample 1 | Sample 2 | (of the | Sample 4 |
| | (control | (control | present | (control |
| Components | sample) | sample) | invention) | sample) |

1. The monomers involve in the reaction

| | | | | |
|---|---|---|---|---|
| n-BMA | 620.68 | 396.92 | 537.11 | 537.11 |
| HEMA | 378.82 | 311.46 | 344.21 | 344.21 |
| Styrene monomer | 0 | 291.12 | 118.18 | 118.18 |
| AIBN | 0.5 | 0.5 | 0.5 | 0.5 |
| T [symbol] ng | 1000.0 | 1000.0 | 1000.0 | 1000.0 |

2. Curing agents

| | | | | |
|---|---|---|---|---|
| Tert-butyl peroxy-3,5,5- | 20 | 20 | 20 | — |
| trimethylhexanoate | | | | |
| Cobalt | 0.2 | 0.2 | 0.2 | — |
| Melamine fomandehyde | — | — | — | 300 |
| P-toluen sulfonic acid | — | — | — | 10 |

1000 g of sample 1 (the control sample, using the content of styrene less than 5% by weight of reaction mixture) synthesized from the components: 620.68 g of n-BMA (54.24% by weight); 378.82 g of HEMA (37.88% by weight); initiator as azo-di-isobutylronitrile (AIBN) 0.5 g (0.05% by weight). The finished acrylic polyol resin sample 1 obtained is cured by adding the catalyst as tert-butyl peroxy-3,5,5-trimethylhexanoate in ratio of 2% by weight (calculated by the weight of finished acrylic polyol resin) and accelerator as cobalt ethylhecxaoctoate solution with concentration of 10% by weight in naphthalene solvent in ratio of 0.02% by weight (calculated by the weight of acrylic polyol resin) for determining curing parameters. 1000 g of sample 2 (the control sample, using the content of styrene higher than 15.5% by weight) synthesized from the components: 396.92 g of n-BMA (39.69% by weight); 219.12 g of styrene (29.11% by weight of reaction mixture); 311.46 g of HEMA (31.15% by weight of reaction mixture); initiator as azobisisobutyronitrile (AIBN) 0.5 g (0.05% by weight of reaction mixture). The finished acrylic polyol resin sample 2 obtained is cured by adding the catalyst as tert-butyl peroxy-3,5,5-trimethylhexanoate in ratio of 2% by weight (calculated by the weight of finished acrylic polyol resin) and accelerator as cobalt ethylhecxaoctoate solution with concentration of 10% by weight in naphthalene solvent in ratio of 0.02% by weight (calculated by the weight of finished acrylic polyol resin) for determining curing parameters.

1000 g of sample 3 (of the present invention) synthesized from the components: 537.11 g of n-BMA (53.71% by weight of reaction mixture); 118.18 g of styrene (11.82% by weight of reaction mixture); 344.21 g of HEMA (34.42% by weight of reaction mixture); initiator as azobisisobutyronitrile (AIBN) 0.5 g (0.05% by weight of reaction mixture). The acrylic polyol resin sample 3 obtained is cured by adding the catalyst as tert-butyl peroxy-3,5,5-trimethylhexanoate in ratio of 2% by weight (calculated by the weight of finished acrylic polyol resin) and accelerator as cobalt ethylhecxaoctoate solution with concentration of 10% by weight in naphthalene solvent in ratio of 0.02% by weight (calculated by the weight of finished acrylic polyol resin) for determining curing parameters.

1000 g of sample 4 (control sample) synthesized from the components: 537.11 g of n-BMA (53.71% by weight of reaction mixture); 118.18 g of styrene (11.82% by weight of reaction mixture); 344.21 g of HEMA (34.42% by weight of reaction mixture); initiator as azobisisobutyronitrile (AIBN) 0.5 g (0.05% by weight of reaction mixture). The finished acrylic polyol resin sample 4 obtained cured with 30% by weight of melamine formaldehyde resin, the catalyst as p-toluene sulfonic acid (PTSA) in the ratio of 1% by weight calculated by the total weight of acrylic and melamine formaldehyde resin, the resin sample cured at 150° C. for determining curing parameters.

The reaction mixture of materials was loaded into a four-neck glass flask with a capacity of 2 liters and copolymerization was carried out in an inert gas atmosphere (N₂) at the temperature in range from 40° C. to 70° C. The reaction time is 5 hours until the viscosity of the reaction mixture at 70° C. is in range from 300 to 400 cP then stopped.

In order to determine the physical and mechanical properties of acrylic polyol resin products after curing, resin samples are prepared according to the above method, however after being mixed with the catalyst-accelerator, the liquid resin mixture is formed into the samples by pouring it into a mold according to the corresponding standard and heating at 100 CC for 60 min for the sample 1, the sample 2, the sample 3 and heating at 150° C. for 60 min for the sample 4.

Technical parameters and physical and mechanical properties of acrylic resin after curing as shown in Table 3 and Table 4.

TABLE 3
Several technical parameters of the liquid acrylic polyol resin products

| | | | Sample | Sample | Sample 3 | Sample |
|---|---|---|---|---|---|---|
| | | | 1 | 2 | (of the | 4 |
| Technical | | Testing | (control | (control | present | (control |
| parameters | Unit | method | sample) | sample) | invention) | sample) |
| Color | Hazen | ASTM | 55 | 10 | 5.6 | 5.8 |
| | | D8005-18 | | | | |
| Non-volatile | % | ASTM | 62.67 | 72.56 | 72.12 | 72.18 |
| content | | D1259-06 | | | | |
| (120° C.-2 | | | | | | |
| hours) | | | | | | |
| Liquid | g/ml | ASTM | 0.95 | 1.05 | 1.08 | 1.03 |
| density 23° C. | | D1475-13 | | | | |
| Brookfield | cP | ASTM | 1500 | 1750 | 1725 | 1738 |
| viscosity at | | C1824-16 | | | | |
| 23° C. | | | | | | |
| Geling time, | min | EN584-00 | 40.0 | 12.0 | 12.75 | 35.58 |
| min | | | | | | |
| Maximum | Phút | EN584-00 | 50.8 | 20.0 | 20.3 | 40.75 |
| uring time | | | | | | |
| Maximum | ° C. | EN584-00 | 156.8 | 212.6 | 210.5 | 172.8 |
| curing | | | | | | |
| temperature | | | | | | |

TABLE 4
Several physical and mechanical properties of acrylic
polyol resin products of example 1 after curing

| | | | | | Sample 3 | |
|---|---|---|---|---|---|---|
| | | | Sample 1 | Sample 2 | present | Sample 4 |
| Technical | | Testing | (control | (control | (of the | (control |
| parameters | Unit | method | sample) | sample) | invention) | sample) |
| Barcol | — | ASTMD2583 | 25 | 42 | 48 | 38 |
| Hardness | | | | | | |
| Tensile | MPa | ISO | 33.6 | 53.12 | 63.58 | 43.6 |
| strength | | 527: 1996 | | | | |
| Flexural | MPa | ISO | 72.16 | 108.06 | 112.06 | 86.16 |
| strength | | 178: 1993 | | | | |
| Tensile | GPa | ISO | 2.06 | 3.52 | 3.60 | 2.56 |
| module | | 527: 1996 | | | | |
| Flexural | GPa | ISO | 2.58 | 4.08 | 4.22 | 3.28 |
| module | | 178: 1993 | | | | |
| Abrasion | g/1000 | ASTMD | 100.6 | 72.16 | 70.5 | 91.62 |
| | cycles | 4060-14 | | | | |

Table 3 shows, at sample 2, the sample 3 use styrene monomer in the reaction mixture and curing by free radical reaction then the technical parameters and physico-mechanical properties of the liquid acrylic polyol resin sample the acrylic polyol resin after curing are almost the same. With sample 1, not using styrene in the reaction mixture then the technical parameters and physico-mechanical properties of liquid resin and resin after curing are lower than those of sample 2 and sample 3. Specifically, with sample 1, liquid resin after synthesizing is a yellowish color, the solid content is 14% lower, curing time lasts 30 minutes longer than sample 2, sample 3. With sample 4, after curing, the finished acrylic polyol resin obtained was cured by functional group reaction then the gelling time, the curing time lasted 20 minutes longer than sample 3, the maximum exothermic temperature is 38° C. lower than sample 3.

Table 4 shows the physico-mechanical properties of the acrylic polyol resin sample 1 after curing which has barcol hardness of 40% lower; tensile strength of 37.7% lower; flexural strength of 34% lower, abrasion 30% higher than sample 2, sample 3. With sample 4, the physical and mechanical properties of the acrylic polyol resin after curing have barcol hardness 20% lower; tensile strength 31.7% lower; flexural strength 23% lower, abrasion 23% higher than sample 3. Thus, styrene has an effect on the chain-stitching ability of the acrylic polyol resins when curing by free radical reaction. The resulting free radical-curing acrylic polyol resin has better physical and mechanical properties than the functional group-curing polyol acrylic resin.

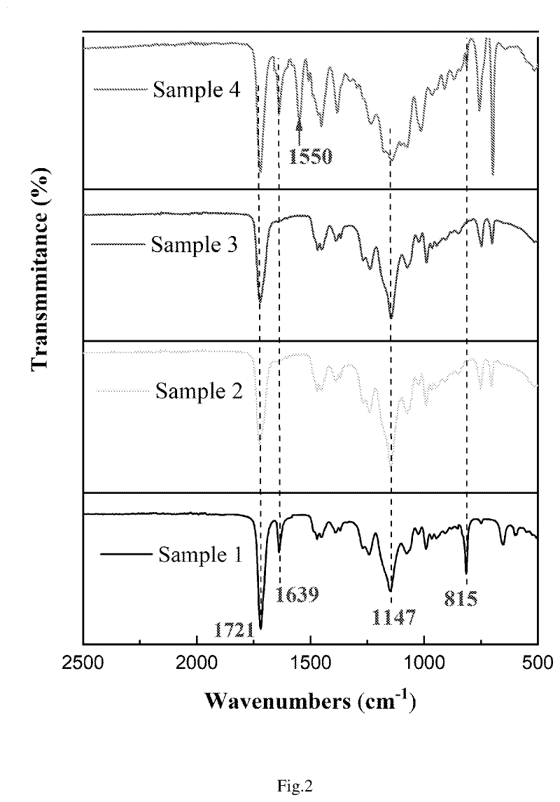

Evaluation of the chain-stitching ability of the acrylic polyol resins by free radical reaction using the catalyst as organic peroxides and accelerator as cobalt octoate and the acrylic polyol resins by functional group reaction was performed via Fourier Transform Infrared Spectroscopy (FTIR) with the results shown on FIG. 2.

FIG. 2 shows that, when the acrylic resin curing by free radical reaction (sample 2, sample 3), the resin samples no longer appear to peak at 1639 cm⁻¹ and 815 cm⁻¹ characterizing for C═C bond in acrylate monomers and hydroxy functional group-containing monomers. This proves that the double bond of the residual monomers in the acrylic resins after synthesizing has participated in the curing reaction completely. On the other hand, with sample 1, apart from peaks at 1721 cm⁻¹ characterizing for C═O bond in the ester group; 1147 cm⁻¹ characterizing C—O—C tensile oscillation, still appears to peak at 1639 cm⁻¹ and 815 cm⁻¹, this proves that the chain-stitching process of the acrylic resin occurs incompletely, the residual monomers after the block copolymerization has not yet fully participated in cross-linking formation.

When curing the acrylic polyol resin by functional group reaction (curing by melamine formaldehyde—sample 4), the FTIR spectrum of the acrylic resin after curing appears to peak at 1639 cm⁻¹ and 815 cm⁻¹ characterizing for C═C bond in acrylate monomers and hydroxy functional group-containing monomers. Apart from peaks at 1721 cm⁻¹ characterizing for C═O bond in the ester group; 1143 cm-1 characterizing C—O—C tensile oscillation; 750 cm⁻¹ characterizing C—H bonds in benzene, the acrylic resin cured by functional group reaction further appears to peak at 1550 cm⁻¹ characterizing for C═N bonds in nitrogen containing heterocyclic ring and peak in melamine formaldehyde (the sample 4).

### Example 2: Evaluation of the Heat Resistance of the Finished Acrylic Polyol Resins after Curing Through Thermogravimetric Analysis (TGA)

Using the acrylic resin samples (sample 1, sample 2, and sample 4) as control samples and the acrylic polyol resin sample of the present invention (sample 3) of example 1.

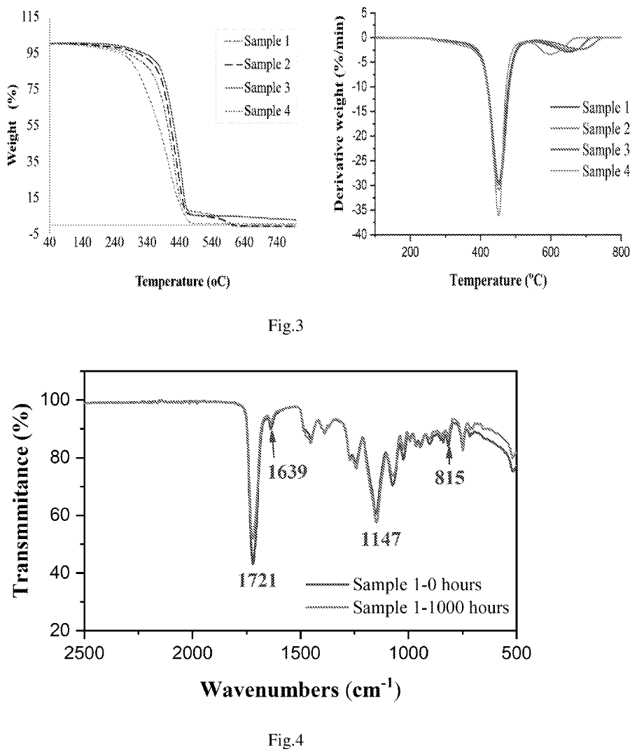

Evaluation of the heat resistance of the finished acrylic polyol resins after curing was performed by TG1600 Setagram, France under anisothermal mode (temperature rises from room temperature to 800° C. at a speed of 10° C./min), airflow 2.5 l/h. Use a 10 ml platinum crucible. Heat resistance of the finished acrylic polyol resin samples after curing is shown in Table 5 and FIG. 3:

TABLE 5
Heat resistance of the acrylic polyol resins after curing

| | T₁₀, | T₅₀, | T₁ₘₐₓ, | T₂ₘₐₓ, | Ash content at |
|---|---|---|---|---|---|
| Samples | ° C. | ° C. | ° C. | ° C. | 800° C., % |
| Sample 1 | 319.30 | 408.84 | 450.38 | 640.18 | 0.22 |
| Sample 2 | 348.24 | 417.23 | 450.78 | 642.35 | 0.25 |
| Sample 3 | 364.70 | 426.99 | 451.9 | 655.27 | 2.86 |
| Sample 4 | 289.93 | 384.06 | 448.38 | 594.27 | 0.21 |

Wherein: T₁₀—temperature at which 10% by weight loss, T₅₀—temperature at which 50% by weight loss, T₁ₘₐₓ—temperature at which the rate of weight loss is maximum at stage 1, T₂ₘₐₓ—temperature at which the rate of weight loss is maximum at the stage.

FIG. 3 shows that, at 200° C. the evaporation of moisture and the original substances do not participate in the reaction. The decomposition of stage 1 begins at 200° C. and occurs relatively rapidly from 300° C. to 500° C., the total weight loss in this period is 90% by weight. At this stage is the breakdown of the cross-linking formed by the acrylate monomers and the acrylic polyol molecular chain followed by the breakdown of the acrylic polyol main chains to form the pyrolysis products. In stage 2, which takes place above 500° C., the weight is burned. It indicates thermal destruction in the presence of oxygen that produces combustion products.

From the result of Table 5, it can be seen that, sample 3 has T₁₀, T₅₀, T₁ₘₐₓ, T₂ₘₐₓ increased from 15 to 61° C. compared with sample 1 and sample 2, the ash content in sample 3 obtained was 92% higher than that of sample 2 and the sample 1. On the other hand, sample 3 cured according to the present invention has T₁₀, T₅₀, T₂ₘₐₓ higher from 42° C.÷75° C. than sample 4 cured by functional group reaction, the ash content in sample 3 obtained is 92% higher than that of sample 4. This proves that sample 3 cured by free radical reaction is heat-stable and has the best UV radiation and weather resistance.

### Example 3: Evaluation of the Ultraviolet Radiation Resistance of the Acrylic Polyol Resin Samples (Sample 1÷the Sample 4 of Example 1) after Curing

The weather resistance and ultraviolet radiation resistance of the acrylic resins are conducted according to ASTM G154-06:2006: Standard of Fluorescent Light Emitting Equipment for Radiation-exposed non-metallic materials. This test was performed on a time accelerometer, a product of ATLAS, USA with four weather simulation modes: ultraviolet radiation (340 nm), humid heat generation, rain spray and dark conditions. Test conditions include an external lamp (340 nm); wavelength: 340 nm; radiant energy: 0.89 W/m2; test cycle: 8 hours of irradiating ultraviolet radiation at the temperature 60±3° C., 4 hours of condensation at the temperature 50±3° C.

Changes in physical and mechanical properties and color of the resin samples (including sample 1, sample 2, sample 3 and sample 4) were obtained from the acrylic resin samples in example 1, respectively, before UV irradiation (0 hours) and after UV irradiation (1000 hours) at the above conditions were determined according to the reflection principle on the colorimeter Xrite C17800, Xrite, USA. The colorimetric method by reflection principle, using color space CIELab; L*; a*; b*; ΔE* according to ASTM E313-10:2010.

Changes in physical and mechanical properties and color of the acrylic polyol resin samples before and after UV irradiation are shown in Table 6 and Table 7.

TABLE 6
Deterioration of physical and mechanical properties of the acrylic
polyol resin samples after irradiating UV for 1000 hours

| | UV | | | | | | |
|---|---|---|---|---|---|---|---|
| Technical | exposure | Barcol | Tensile | Flexural | Tensile | Flexural | |
| parameters | time | hardness | strength | strength | module | module | Abrasion |
| Unit | hour | — | MPa | MPa | GPa | GPa | g/1000 |
| | | | | | | | cycles |
| Sample 1 | 0 | 28 | 33.6 | 72.16 | 2.06 | 2.58 | 100.6 |
| | 1000 | 10 | 13.6 | 32.16 | 1.26 | 1.88 | 150.7 |
| Sample 2 | 0 | 42 | 53.12 | 108.06 | 3.52 | 4.08 | 72.16 |
| | 1000 | 32 | 40.15 | 80.12 | 2.42 | 3.16 | 102.16 |
| Sample 3 | 0 | 48 | 63.58 | 112.06 | 3.60 | 4.22 | 70.5 |
| | 1000 | 42 | 56.62 | 108.6 | 3.42 | 4.06 | 80.16 |
| Sample 4 | 0 | 38 | 43.6 | 86.16 | 2.56 | 3.28 | 91.61 |
| | 1000 | 19 | 25.12 | 50.18 | 1.14 | 1.42 | 152.64 |

Table 6 shows, after 1000 hours of UV exposure, the physico-mechanical properties of the sample 1, sample 2 and sample 4 (control samples) show a significant decline, while the sample 3 shows slight decrease. Specifically, after 1000 hours of UV exposure, the Barcol hardness decreased by 64% in sample 1, 47% in sample 2, 12.5% in sample 3, 50% in sample 4; the tensile strength decreased by 60% in sample 1, 24% in sample 2, 11% in sample, 42.8% in the sample 4; the flexural strength decreased by 55% in sample 1, 26% in sample 2, 3.5% in sample 3, 41.8% in sample 4; the abrasion increased by 33% in the sample 1, 25% in the sample 2, 12.5% in the sample 3, 40% in the sample 4 compared to the samples before irradiating UV. Thus, sample 3 of the present invention is more thermal stable, UV and weather resistance than that of sample 1, sample 2 and sample 4.

TABLE 7
The color variation of the acrylic polyol resin
samples after 1000 hours of UV exposure

| Parameter | Sample 1 | Sample 2 | Sample 3 | Sample 4 |
|---|---|---|---|---|
| ΔE* | 10.65 | 4.86 | 1.55 | 11.62 |

Table 7 shows that, after UV exposure, the color variation of the control samples (sample 1, sample 2 and sample 4) exhibit remarkable color variation, namely, after 1000 hours of UV exposure, the color index ΔE* of sample 1 is 10.65, the sample 2 is 4.86 and the sample 4 is 11.62. Meanwhile, the color index ΔE* sample 3 (of the present invention) shows a value of 1.55 which is 6.8 times lower than sample 1, 3.14 times lower than sample 2 and 7.5 times lower than sample 4. Thus, the free radical curing mechanism of the present invention helps to increase the UV radiation resistance of acrylic polyol resins.

This can be explained as follows: In sample 1, the hardened acrylic resin obtained by free radical reaction, the chain-stitching process was slow and incomplete. Under the effect of UV radiation, the unstable double bonds —C═C-remaining in the monomer and acrylic copolymer are easily destroyed forming chromogenic groups, thus, the color of the sample 1 changes drastically. In sample 2, due to the high content of styrene in the molecular structure of the hardened acrylic resin, the —C═C— bond in the aromatic ring has a K-electron vibration plane located perpendicular to the bond, this results in forming an unstable bond. This bond is easily decomposed under UV exposure and turned into colored ketone groups (—C═O—). In the resin molecular chain, the more these unstable —C═C— bonds are, the easier it is to break, the color of the resin sample (sample 2) changes markedly. In sample 4, the acrylic polyol resin cured by a functional group mechanism using a hot curing agent as melamine formaldehyde and a catalyst as para-toluene sulfonic acid. In which, the melamine formaldehyde curing agent has the unstable double bond (—C═C—) in the aromatic ring which leads to the polymer chain being destroyed easily under the effect of UV irradiation.

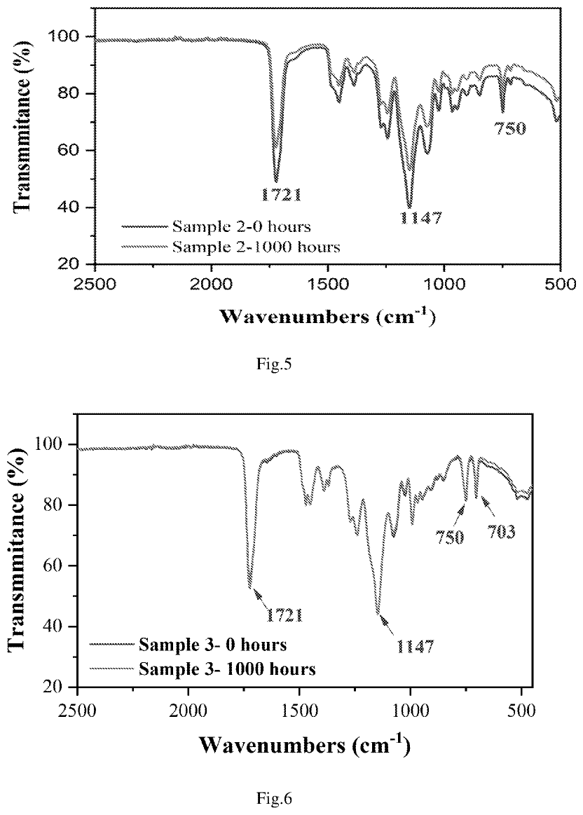

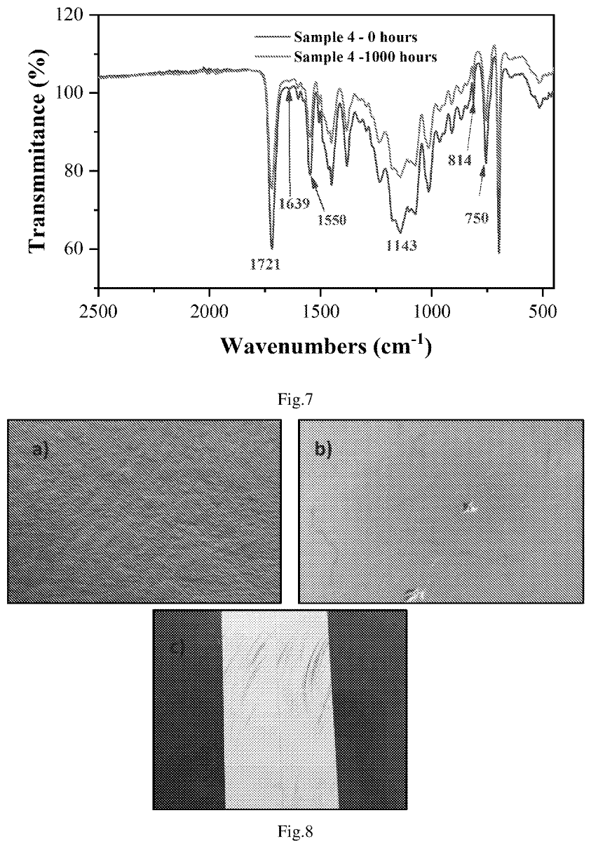

FTIR spectrums of the cured resin samples that include sample 1, sample 2, sample 3 and sample 4 after ultraviolet irradiation are shown in FIG. 4, FIG. 5, FIG. 6 and FIG. 7.

FIG. 4 shows the FTIR infrared spectrum of the acrylic resin cured by functional group reaction (sample 1 is the control sample) before UV irradiation (0 hours) and after UV irradiation (1000 hours) on time-accelerated ultraviolet radiation test equipment. As shown in FIG. 4, after 1000 hours of UV irradiation, the peak intensity at 1639 cm⁻¹ and 815 cm⁻¹, which characterize the —C═C— bond in the acrylic resin, decreases sharply and this indicates thermal aging in the molecular structure of the acrylic resin after curing. On the other hand, the peak intensity at 1721 cm⁻¹ characterizes for C═O bond and 1147 cm⁻¹ characterizes for C—O bond both strongly decreased, this indicates that the ester bonds were destroyed to form new bonds due to photooxidation.

FIG. 5 shows the FTIR spectrum of the acrylic resin cured by functional group reaction (sample 2 is the control sample) before UV irradiation (0 hours) and after UV irradiation (1000 hours) on time-accelerated ultraviolet radiation test equipment. As shown in FIG. 5, after 1000 hours of UV irradiation, the peak intensity at 1721 cm⁻¹ characterizes for C═O bond and 1147 cm⁻¹ characterizes for C—O bond both strongly decreased, this indicates that the ester bonds were destroyed to form new bonds due to photooxidation. In addition, the absorption peak at 750 cm⁻¹, which characterizes by the bending vibration of the C—H bond in the benzene ring, is strongly reduced, this indicates the thermal aging in the structure of the acrylic resin.

FIG. 6 shows the FTIR spectrum of the acrylic resin cured by free radical reaction (sample 3 of the present invention) before UV irradiation (0 hours) and after 1000 hours of UV exposure on UV Testing. As shown in FIG. 6, after 1000 hours of UV irradiation, the peak intensity at 1721 cm⁻¹ characterizes for C═O bond and 1147 cm⁻¹ characterized for C—O bond is not significantly reduced compared to the acrylic sample before UV irradiation. In addition, the absorption peak at 750 cm⁻¹ characterizes for the C—H bond in the benzene ring, almost coincides with the FTIR spectrum of the resin sample before UV irradiation. Thus, it can be seen that the acrylic resin cured by free radical reaction has better UV radiation and weather resistance than the acrylic resin cured by functional groups.

FIG. 7 shows the FTIR infrared spectrum of the acrylic resin cured by functional group reaction (sample 4 is the control sample) before (0 hours) and after 1000 hours of UV exposure on UV Testing. As shown in FIG. 7, after 1000 hours of UV exposure, the intensity of all peaks of functional groups decreases sharply, in which the peak intensity at 1639 cm⁻¹ and 815 cm⁻¹ characterize for the C═C bond in the acrylic resin, the peak at 1550 cm⁻¹ characterize for the C═N bond in the nitrogen containing heterocyclic ring, and the peak at 750 cm⁻¹ characterizes for the C—H bond in the benzene ring. This indicates thermal aging in the molecular structure of the acrylic resin after curing. On the other hand, the peak intensity at 1721 cm⁻¹ characterizes for C═O bond and 1143 cm⁻¹ characterizes for C—O bond both strongly decreased, this indicates that the ester bonds were destroyed to form new bonds due to photooxidation.

### Example 4: The Effect of the Acrylic Polyol Resin of Example 1 on Machinability, Physical and Mechanical Properties of Quartz-Based Artificial Stone Products

Using the acrylic resin samples (sample 1, sample 2 and sample 4) of example 1, the unsaturated polyester resin (UPR) cures by the addition of a catalyst of tert-butyl peroxy-3,5,5-trimethylhexanoate in the ratio of 2% by weight (compared to UPR resin weight) and accelerator as 10% by weight cobalt ethylhecxaoctoate solution in naphthalene solvent in the ratio of 0.02% by weight (compared to UPR resin) as a control sample and the acrylic polyol resin sample of the present invention (the sample 3) of Example 1 to make the artificial stone samples at the lab.

The quartz-based artificial stone samples were made by vibration pressing in vacuum technology and hot cured at the temperature of 130° C. for 60 minutes for sample 1, sample 2, sample 3, and UPR, and cured at 150° C. for 60 minutes for sample 4, with dimensions of 300×300×20 (mm). The total weight of materials to make the artificial stone sample is 5000 g. In which, the components of the mixture to make the artificial stone sample include 625 g of the resin (12.5% by weight of the whole materials), this resin sample has already included 2.0% by weight of 3-(trimethoxy silyl)propyl methacrylate and the catalyst—accelerator, curing agent according to the example 1; 1200 g of cristobalite powder with particle size ≤0.045 mm (24% by weight of the whole materials); 1050 g of cristobalite aggregate with particle size in the range of 0.1÷0.4 mm (21% by weight of the whole materials); 1100 g of quartz aggregate with particle size in the range of 0.1÷0.4 mm (22% by weight of the whole materials); 925 g of quartz aggregate with particle size in the range of 0.3÷0.7 mm (18.5% by weight of the whole materials) and 100 g of with TiO₂ powder (2.0% by weight of the whole materials).

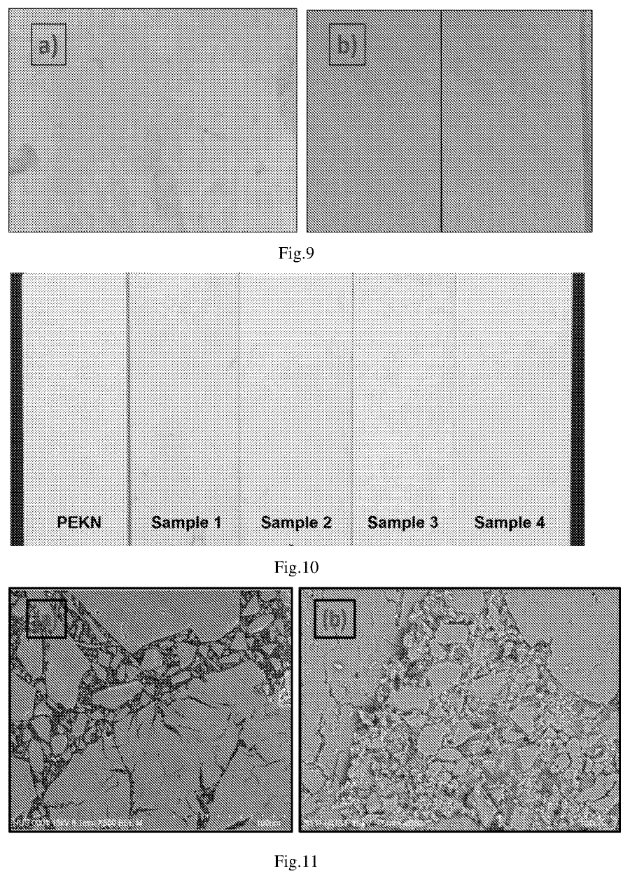

Producibility and physico-mechanical properties of the artificial stone products with the above-mentioned composition are shown in FIG. 8, FIG. 9, table 8 and table 9:

TABLE 8
Comparison of the producibility of the artificial
stone samples using different resin binder

| | The matrix resins | | | | |
|---|---|---|---|---|---|
| Parameters | PEKN | Sample 1 | Sample 2 | Sample 3 | Sample 4 |
| Material mobility | Flexible | Less | Flexible | Flexible | Less |
| after vibrating | | flexible | | | flexible |
| compression | | | | | |
| Curing temperature | 130 | 130 | 130 | 130 | 150 |
| (° C.) | | | | | |
| Curing time (min) | 60 | 90 | 60 | 60 | 60 |
| The sample after | The sample | The | The sample is not | | The |
| curing | is not | sample is | blistered and pitted | | sample is |
| | blistered | blistered | | | blistered |
| | and pitted | and pitted | | | and pitted |
| The ability | Easy | scratches | Easy grinding, no | | scratches |
| to grind | grinding, | on the | scratches on the surface | | on the |
| | no | surface | | | surface |
| | scratches | when | | | when |
| | on the | grinding | | | grinding |
| | surface | | | | |

The artificial stone product using the matrix phase of the acrylic resin sample (control sample) has a curing time of 30 minutes longer than that of sample 2, sample 3 and [symbol] resin. Sample 1 and sample 4 after vibrating are less flexible, dry, and the stone samples after curing have blistered surfaces, surface scratches and poor gloss that appear after grinding (FIG. 8 and Table 8). Samples 2, the sample 3 and [symbol] sample have similar curing times, flexible after vibrating, and without surface scratches atter polishing (FIG. 9 and Table 8).

TABLE 9
The effect of the matrix resins on the physico-mechanical
properties of the artificial stone products

| | | | | Scratch |
|---|---|---|---|---|
| | | | | hardness |
| Physical and | Flexural | Water | Impact | of the |
| mechanical | strength, | absorption, | resistance, | surface, |
| properties | N/mm² | % | J | Mohs |
| Testing | BS EN | BS EN | BS EN | EN |
| method | 14617- | 14617- | 14617- | 101: 1991 |
| | 2: 2016 | 1: 2013 | 9: 2005 | |
| Standard | 40.0 ÷ 120.0 | 0.01 ÷ 0.05 | ≥3.0 | 6.0 ÷ 8.0 |
| value | | | | |
| UPR | 66.12 | 0.021 | 7.05 | 7.0 |
| Sample 1 | 33.16 | 0.062 | 4.15 | 3.0 |
| Sample 2 | 66.02 | 0.024 | 7.06 | 7.0 |
| Sample 3 | 73.12 | 0.018 | 7.08 | 7.0 |
| Sample 4 | 53.01 | 0.041 | 5.25 | 6.0 |

Table 9 shows that, the artificial stone product using the matrix phase of the acrylic polyol resin sample 3 (of the present invention) has flexural strength 50% higher than sample 1, 9.6% higher than sample 2, 27.4% higher than sample 4; water absorption reduced compared to the sample 1 is 71%, sample 2 is 25%, sample 4 is 56%, compared to the artificial stone sample using UPR resin is 9%. This proves that the artificial stone product using acrylic polyol resin binder of this patent has a better and more specific adhesion between aggregate particles than other resin binder, therefore the physico-mechanical properties of obtained artificial stone products based acrylic polyol resin was enhanced.

### Example 5: Evaluation of UV and Weather Resistance of the Quartz-Based Artificial Stone Samples

The quartz-based artificial stone products using the acrylic resins (sample 1, sample 2 and sample 4) of example 1, the unsaturated polyester resin (UPR) of example 4 are the control samples and the acrylic polyol resin sample of the present invention (the sample 3) of example 1 are used to make the artificial stone samples at the lab.

These artificial stone products used the ratios of cristobalite granular aggregate, quartz granular aggregate, and the ratios of the resin as in example 4.

The artificial stone samples, which have demission of 300×80×20 (mm) after fabrication, and have been polished their surfaces (gloss ≥50 GU), are tested for weather and ultraviolet radiation resistance according to ASTM G154-06:2006 and evaluated the color variation according to ASTM E313-10:2010 as described by example 2, and determined the surface gloss as according to ISO 2813:1994: Standard for determining the gloss of metal materials, on gloss meter IG 320, Horiba, Japan, measuring angle of 60° C. for medium-gloss material surface (gloss in range of 10÷70 GU).

Changes in physical and mechanical properties of the artificial stone products using the matrix resins of example 1 and the UPR resin are shown in Table 10.

TABLE 10
Physical and mechanical properties before (0 hour) and after 1000 hours of
UV exposure of the artificial stone products using different resin binder

| Physical and | Irradiating | | Flexural | Water | Impact | Scratch |
|---|---|---|---|---|---|---|
| mechanical | time | | strength, | absorption, | resistance, | hardness of |
| properties | UV, hours | | N/mm² | % | J | surface, Mohs |
| Testing | — | | BS EN 14617- | BS EN 14617- | BS EN 14617- | EN |
| method | | | 2: 2016 | 1: 2013 | 9: 2005 | 101: 1991 |
| Standard value | — | | 40.0 ÷ 120.0 | 0.01 ÷ 0.05 | ≥3.0 | 6.0 ÷ 8.0 |
| PEKN | 0 | hour | 66.12 | 0.023 | 7.05 | 7.0 |
| | 1000 | hours | 55.02 | 0.035 | 6.02 | 6.0 |
| Sample 1 | 0 | hour | 33.16 | 0.062 | 4.15 | 3.0 |
| | 1000 | hours | 23.16 | 0.096 | 2.32 | 2.0 |
| Sample 2 | 0 | hour | 66.02 | 0.021 | 7.06 | 7.0 |
| | 1000 | hours | 58.15 | 0.028 | 6.10 | 6.0 |
| Sample 3 | 0 | hour | 73.12 | 0.018 | 7.08 | 7.0 |
| | 1000 | hours | 72.16 | 0.019 | 7.01 | 7.0 |
| Sample 4 | 0 | hour | 53.01 | 0.041 | 5.25 | 6.0 |
| | 1000 | hours | 41.88 | 0.062 | 3.15 | 5.0 |

From Table 10, it can be seen that, after 1000 hours of UV exposure, sample 3 (of the present invention) has insignificant changes in physical and mechanical properties in comparison with the sample before UV exposure. While, the artificial stone sample using UPR resin binder in sample 1, sample 2 and sample 4, physico-mechanical properties have significantly reduced after 1000 hrs of UV exposure. In which, the flexural strength decreased by 16% in the UPR sample, decreased by 30% in sample 1, decreased by 12% in sample 2, decreased by 22.6% in sample 4 respectively compared to that property before UV exposure; the water absorption increased by 34% in the UPR binder, increased by 36% in sample 1, increased by 25% in sample 2, increased by 33.8% in sample 4 respectively compared to that property before UV exposure; the impact resistance decreased by 14% in the UPR binder, decreased by 50% in sample 1, decreased by 14% in sample 2, decreased by 40% in sample 4 respectively compared to that property before UV exposure. This proves, after 1000 hours of UV exposure, the surface of the stone product using the resin sample 3 has not been destroyed, the dense structure leads to almost unchanged physico-mechanical properties. In the artificial stone products using the matrix resins of sample 1, sample 2, sample 4 and the UPR resin, after 1000 hours of UV exposure, the surface of the stone products has been destroyed resulting in a non-dense structure that degrades physico-mechanical properties.

The change in color and gloss of the surface of the artificial stones, that use the matrix acrylic resin of example 1 and the UPR resin, correlating with the UV irradiating time after 500 hours and 1000 hours are shown in Table 11.

TABLE 11
The discoloration (ΔE*) and gloss of the surface of
the artificial stones using the acrylic polyol resin (example
1) and the UPR resin correlate with UV exposure time

| | | UV exposure time, hrs. | | |
|---|---|---|---|---|
| The resin samples | Parameters | 0 hour | 500 hours | 1000 hours |
| UPR | ΔE* | 0 | 5.72 | 8.92 |
| The sample 1 (control) | | 0 | 7.48 | 10.63 |
| The sample 2 (control) | | 0 | 2.01 | 4.52 |
| The sample 3 (of the | | 0 | 0.22 | 0.38 |
| present invention) | | | | |
| The sample 4 (control) | | 0 | 6.28 | 9.22 |
| UPR | Gloss, GU | 58 | 43 | 35 |
| The sample 1 (control) | | 32 | 12 | 6 |
| The sample 2 (control) | | 58 | 45 | 38 |
| The sample 3 (of the | | 62 | 58 | 54 |
| present invention) | | | | |
| The sample 4 (of the | | 42 | 25 | 18 |
| present invention) | | | | |

From Table 11 and FIG. 10 show that, the artificial stone samples using the acrylic resins of sample 1, sample 2, sample 4 and UPR resin have a significant discoloration and a rapid decline in gloss, especially in the sample 1. After 500 hours and 1000 hours of UV exposure, the discoloration ΔE* of 5.72 and 8.92 respectively and the gloss decreased by 15 GU and 23 GU after 500 hours and 1000 hours of UV exposure respectively for UPR; the discoloration ΔE* of 7.48 and 10.63 respectively and the gloss decreased by 20 GU and 26 GU after 500 hours and 1000 hours of UV exposure respectively for the acrylic resin sample 1; the discoloration ΔE* of 2.01 and 4.52 respectively and the gloss decreased by 13 GU and 20 GU after 500 hours and 1000 hours of UV exposure respectively for the acrylic resin sample 2; the discoloration ΔE* of 6.28 and 9.22 respectively and the gloss decreased by 17 GU and 24 GU after 500 hours and 1000 hours of UV exposure respectively for the acrylic resin sample 4. Meanwhile, the artificial stone sample using the acrylic polyol matrix resin of the present invention (sample 3) has a little change in color and gloss of the stone surface after 1000 hours of UV exposure. At the same UV exposure time of 500 hours and 1000 hours, the color change ΔE* in sample 3 of the present invention is 10÷25 times lower than that using the matrix resin of sample 1, sample 2, sample 4 and PR resin.

To evaluate the impact of UV irradiation on the structural morphology of the artificial stone samples using the acrylic resin of example 1, scanning electron microscopy (SEM) images of the artificial stone samples were taken before UV irradiation (0 hours) and after UV irradiation (1000 hours). SEM images of the artificial stone samples using the UPR resin—control sample, the acrylic resin of example 1 (sample 2, sample 4—the control samples and sample 3 of the present invention) at 500× magnification were shown in FIG. 11 to FIG. 14.

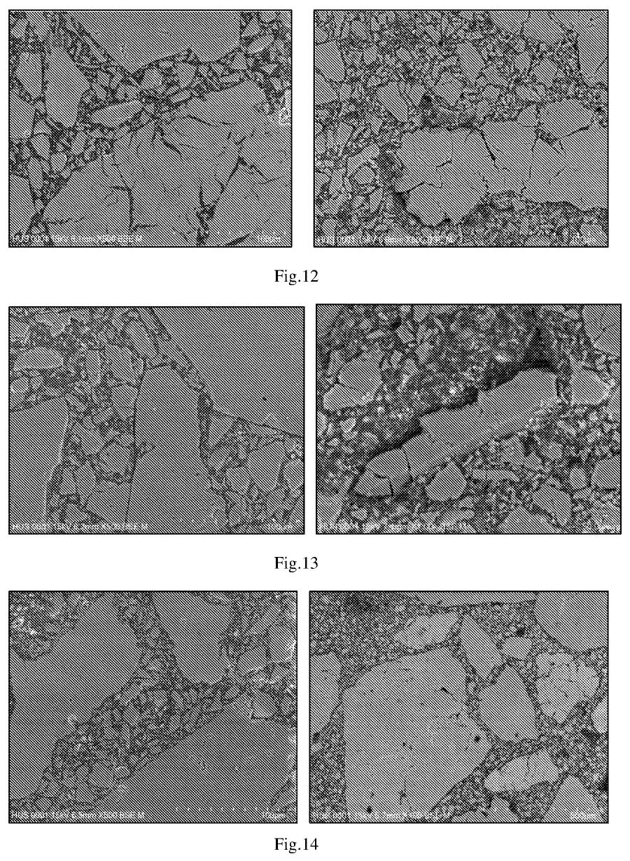

FIG. 11, FIG. 12, FIG. 13 show that, before irradiating UV, the artificial stone samples using the acrylic polyol resin of sample 2, sample 4 and UPR resin have a dense structure, wherein the matrix resin is closely bonded with quartz granular aggregate. (FIG. 11a, FIG. 12a, FIG. 13b). However, after irradiating UV for 1000 hours on the time accelerometer, the surfaces of the artificial stones are aged, the bond between the matrix resin and the granular aggregate is destroyed (FIG. 11b, FIG. 12b and FIG. 13b).

FIG. 14 shows that, before irradiating UV, the artificial stone sample using the acrylic polyol resin of the present invention (sample 3) has a dense structure, wherein the matrix resin is closely bonded with the granular aggregate (FIG. 14a). After irradiating UV for 1000 hours, the surface of the artificial stone is virtually undamaged (FIG. 14b), this indicates that the bond between the matrix resin and the granular aggregate are closely bonded and the dense material structure is shown through the decrease of the gloss and the discoloration on the surface of the artificial stone product (table 4). This result confirms that the artificial stone sample using the acrylic polyol resin cured by free radical reaction in the present invention has excellent UV and weather resistance.

### THE ADVANTAGEOUS EFFECT OF THE INVENTION

Unlike an acrylic polyol resin cures by the reaction of functional groups, in the present invention, the acrylic polyol resin, synthesized by block copolymerization from n-BMA monomers, styrene monomer and HEMA or HEA monomers cured by free radical reaction with a catalyst-accelerator which is an oxidation-reduction system, has excellent UV and weather resistance while the technical parameters and mechanical properties meet the requirements for use in an artificial stone product. The UV and weather resistance of the acrylic polyol resin cured by the free radical reaction of the present invention is also confirmed when applied to make the quartz-based artificial stone samples. This confirms that the acrylic resin cured by free radical reaction of the present invention fully meets the requirements for application in quartz-based artificial stone production technology.

1. Thermal curable hydroxyl-containing acrylic resin composition (acrylic polyol resin), curing by free radical reaction with a catalyst-accelerator which is an oxidation-reduction system, for manufacturing artificial stone to enhance UV and weather resistance, wherein the composition comprising:
(a) ultraviolet radiation and weather-resistant acrylic polyol resin synthesized from monomer n-butyl methacrylate (n-BMA), styrene, hydroxyethyl methacrylate (HEMA), or 2-hydroxyethyl acrylate (HEA) with the following component ratios:
(i) n-BMA in the range of 51.5% to 60.5% by weight,
(ii) styrene in the range of 5.0% to 15.5% by weight,
(iii) HEMA or HEA in the range of 33.5% to 45.6% by weight,
(iv) synthesis reaction initiator chosen from the group consisting of dibenzoyl peroxide or di-t-butyl peroxide or azo-di-isobutylronitrile or a combination thereof in the range of 0.01% to 2% by weight calculated by the total weight of the reaction mixture;
(b) curing catalysts, which is organic peroxide compound, chosen from group consisting of tert-butylperoctoate; tert-butyl peroxybenzoate; tert-butyl peroxy-3,5,5-trimethylhexanoate; ter-butylperoxy-pivalate; tert butyl peroxy-2 ethylhexanoate; tert butyl peroxy-isobutyrate; tert butyl-monoperoxy-maleate; tert butyl peroxy-neoheptanoate; tert butylperoxy-neodecanoate; di(4-methyl benzoyl)peroxide; diluaroyl-peroxide; 2,5-dimethyl-2-5-di(2-ethylhexanoylperoxy)hexane; di(3,5,5-trimethyl-hexanoyl)peroxide; tert amylperoxy-neodecanoate; 1,1,3,3-tetramethylbutylperoxy-neodecanoate or combination thereof in range from 0.1 to 5% by weight calculated by the weight of the acrylic polyol resin;
(c) curing accelerator chosen from a group consisting of cobalt (II) salt compounds, preferably cobalt (II) octoate, or manganese salts in the range of 0.005% to 1% by weight calculated by the weight of the acrylic polyol resin.

2. Thermal-curable acrylic polyol composition according to claim 1, wherein the finished acrylic polyol composition has physical and mechanical properties as follows:
i) solid content in the range of 40% to 80%;
ii) color according to Hazen scale ≤10;
iii) liquid density in the range of 1.01 to 1.2 g/cm³ at the temperature of 23° C. and the relative humidity of 57%;
iv) viscosity in the range of 600 to 3000 mPa·s at the temperature of 23° C.;
v) tensile strength in the range of 40 to 60 MPa;
vi) flexural strength in the range of 60 to 120 MPa;
vii) barcol hardness in the range of 40 to 55;
viii) ultraviolet radiation and weather resistance with color variation index ΔE≤2.

3. Artificial stone products consisting of:
(a) the matrix phase of the acrylic polyol resin according to claim 1 in the range of 5% to 20% by weight;
(b) reinforcements are inorganic granular aggregates in the range of 80% to 95% by weight, wherein the inorganic granular aggregate comprises:
quartz granular aggregate, cristobalite, sand, and sand or glass derivatives materials which have particle size ≤0.045 mm in the range of 10% to 37.5% by weight,
quartz granular aggregate, cristobalite, sand, and sand or glass derivatives materials with a particle size from 0.045 mm to 0.1 mm in the range of 15% to 42.5% by weight,
quartz granular aggregate, cristobalite, sand, and sand or glass derivatives materials with a particle size from 0.1 mm to 0.5 mm in the range of 10% to 37.5% by weight,
quartz granular aggregate, cristobalite, sand, and sand or glass derivatives materials with a particle size from 0.5 mm to 2.5 mm in the range of 17.5% to 45.6% by weight,
quartz granular aggregate, cristobalite, sand, and sand or glass derivatives materials with a particle size from 2.5 mm to 6.0 mm in the range of 20% to 47.5% by weight.

4. Artificial stone product according to claim 3, wherein the artificial stone has physical and mechanical properties as follows:
i) flexural strength in the range of 40 to 120 N/mm²;
ii) deep abrasion in the range of 89 to 175 mm³;
iii) water absorption in the range of 0.01% to 0.05%;
iv) impact resistance ≥3 J;
v) UV and weather resistance with the discoloration index ΔE*≤2 after 1000 hours of UV exposure in the UV Testing.
